(19) United States
(12) Patent Application Publication
(10) Pub. No.: US 2008/0026842 A1
(43) Pub. Date: Jan. 31, 2008

(54) GAME PROGRAM, GAME DEVICE, AND GAME METHOD

(75) Inventor: Noboru NAKASAKA, Tokyo (JP)

Correspondence Address: GLOBAL IP COUNSELORS, LLP, 1233 20TH STREET, NW, SUITE 700, WASHINGTON, DC, 20036-2680, US

(73) Assignee: KONAMI DIGITAL ENTERTAINMENT CO., LTD., Tokyo (JP)

(21) Appl. No.: 11/846,153

(22) Filed: Aug. 28, 2007

Related U.S. Application Data
(63) Continuation of application No. PCT/JP2006/305368, filed on Mar. 17, 2006.

(30) Foreign Application Priority Data
Mar. 24, 2005 (JP) 2005-086922

(51) Int. Cl. A63F 13/00

(52) U.S. Cl. 463/37

(57) ABSTRACT

The present invention allows a player to easily instruct a character displayed on a monitor to execute a plurality of commands. If an input signal is input from a contact input type monitor, an input position on the contact input type monitor, which corresponds to the input signal, is recognized based on the input signal from the contact input type monitor. Then, it is judged if the input position is located within the display areas of at least two command icons of a plurality of command icons. Subsequently, at least two command icons are selected if it is judged that the input position was located within the display areas of the at least two command icons. A new command is generated based on commands assigned to each of the selected at least two command objects, and the character is instructed to execute the new command.

### CROSS-REFERENCE TO RELATED APPLICATIONS

This application is a continuation of national phase application of International application No. PCT/JP2006/305368, filed on Mar. 17, 2006, which claims priority to Japanese Application No. 2005-086922, filed in Japan on Mar. 24, 2005, the entire contents of which are hereby incorporated herein by reference.

### BACKGROUND OF THE INVENTION

1. Field of the Invention

The present invention generally relates to a game program. More specifically, the present invention relates to a game program for executing a game on a computer.

2. Background Information

A variety of video games have been proposed in the past. The video games are configured to be executed on game devices. For example, a general game device (or a general game console) includes a monitor, a core unit that is provided separately from the monitor, and an input unit (e.g., a controller) that is provided separately from the core unit. A plurality of input buttons is arranged on the controller. Also, a portable game device includes a core unit, a liquid crystal device monitor (hereinafter called “LCD monitor”) provided on approximately a central portion of the core unit, and an input unit (e.g., a plurality of input buttons) arranged on both sides of the LCD monitor. In this type of game device, a player can instruct a character displayed on the monitor to execute a variety of commands by controlling the input unit.

As one of the plurality of video games that have been proposed in the past, a versus-type game has been known in which a player instructs a character displayed on a monitor to execute a command related to match-up by controlling an input unit (e.g., input buttons).

For example, a battle simulation game will be hereinafter assumed in which a player can move a tank character of his/her ally or he/she can make the tank character of his/her ally fire at a tank character of his/her enemy.

In this type of battle simulation game, first of all, characters of a player's ally (e.g., a plurality of tank characters) are configure to be displayed on a monitor, and a group of icons, which are comprised of a movement instruction icon for moving the tank characters, a gunshot instruction icon used for making the tank characters firing at a target, and the like, are configured to be displayed on the monitor. Next, a tank character of a player's ally, which is an object of a command, is configured to be selected by controlling an input button (e.g., a direction instruction button). Subsequently, an object to be selected, that is, a highlight, is configured to be moved from the tank character to the group of icons by controlling an input button (e.g., a button on which a triangle-mark is put). Then, a command that the selected tank character is instructed to execute is allowed to be selected from the group of icons by controlling an input button (e.g., a direction instruction button). Finally, the selected tank character is configured to be instructed to execute a command assigned to the selected icon by controlling an input button (e.g., a button on which a circle-mark is put).

For example, after a tank character of a player's ally is selected by controlling the direction instruction button, it is possible to move a highlight from the tank character to the group of icons by controlling the button on which a triangle-mark is put. Then, if a forward movement instruction icon is selected by controlling a direction instruction button and the button on which the circle-mark is put is controlled, it is possible to move the selected tank character forward. Also, if a rightward movement instruction icon is selected by controlling a direction instruction button and the button on which the circle-mark is put is controlled, it is possible to further move the tank character, which was moved forward, in the rightward direction. As described above, it is possible to move the selected tank character to a desired position by repeatedly controlling the direction instruction button and the button on which the circle mark is put. Finally, if a gunshot instruction icon is selected by controlling a direction instruction button and the button on which the circle-mark is put is controlled, it is possible to make the tank character, which was moved to a desired position, fire at the enemy.

In the above described type of video games in which a player instructs an object character to execute a variety of commands by selecting an icon through the control of the input unit, he/she often preliminarily decides what kind of command should be instructed to a character to execute and then selects the icon that corresponds to the decided command by controlling the input unit. For example, in the case of the above described battle simulation game, a player preliminarily decides a position to which a tank character is instructed to moved and then fire at the enemy. Based on the preliminary decision, the player selects an icon that corresponds to an action of the selected tank character by controlling the input unit.

A procedure of controlling the input unit at this time will be hereinafter explained. First, a direction instruction button is controlled to select a tank character, and a button on which a triangle-mark is put is controlled to move a highlight from the tank character to a group of icons. Then, a direction instruction button is controlled to select a forward movement instruction icon, and a button on which a circle-mark is put is controlled to move the selected tank character forward. Subsequently, a direction instruction button is controlled to select a rightward movement instruction icon, and a button on which a circle-mark is put is controlled to further move the selected tank character, which was moved forward, in the rightward direction. Finally, a direction instruction button is controlled to select a gunshot instruction icon, and the button on which the circle-mark is put is controlled to make the tank character fire at the enemy.

As described above, even though a player's tactics with respect to a tank character is preliminarily decided, a procedure of controlling a plurality of buttons is required to instruct the character to execute a command when the player actually performs a command instruction for the tank character. In other words, the problem is that the player's control for performing a command instruction to a tank character will be complicated.

In view of the above, it will be apparent to those skilled in the art from this disclosure that there exists a need for an improved character instruction. This invention addresses this need in the art as well as other needs, which will become apparent to those skilled in the art from this disclosure.

### SUMMARY OF THE INVENTION

The object of the present invention is to allow a player to easily instruct a character displayed on a monitor to execute a plurality of commands.

A game program in accordance with a first aspect is a program for implementing the following functions on a computer for executing a game in which a plurality of command objects to instruct a character displayed on at least either of a contact input type monitor and a non-contact input type monitor to execute a command are displayed on the contact input type monitor.

(1) A command object display function for displaying a plurality of command objects on the contact input type monitor.

(2) A command assignment function for assigning a command to each of a plurality of command objects.

(3) An input position recognition function for recognizing an input position on a contact input type monitor based on an input signal from the contact input type monitor, the input position corresponding to the input signal.

(4) A first input position judgment function for judging if an input position is located within display areas of at least two command objects of a plurality of command objects while the input position on the contact input type monitor is being continuously recognized.

(5) An object selection function for selecting at least two command objects if it is judged that the input position is located within the display areas of at least the two command objects of the plurality of command objects while the input position on the contact input type monitor is being continuously recognized.

(6) A command generation function for generating a new command based on the command assigned to each of at least the selected two command objects.

(7) A new command instruction function for instructing the character to execute the new command.

According to a game executed by this program, in the command object display function, the plurality of command objects are displayed on the contact input type monitor. In the command assignment function, the command is assigned to each of the plurality of command objects. In the input position recognition function, an input position on the contact input type monitor corresponding to an input signal from the contact input type monitor is recognized based on the input signal. In the first input position judgment function, it is judged if the input position is located within display areas of at least two command objects of a plurality of command objects while the input position on the contact input type monitor is being continuously recognized. In the object selection function, at least two command objects are selected if it is judged that the input position is located within the display areas of at least the two command objects of the plurality of command objects while the input position on the contact input type monitor is being continuously recognized. In the command generation function, a new command is generated based on the command assigned to each of at least the selected two command objects. In the new command instruction function, the character is instructed to execute the new command.

According to this game program, a plurality of command objects are displayed on a contact input type monitor. A command is assigned to each of the plurality of command objects. If an input signal is input from the contact input type monitor on this state, an input position on the contact input type monitor, which corresponds to the input signal, is recognized based on the input signal from the contact input type monitor. It is judged if the input position on the contact input type monitor is located within the areas of at least two command objects of a plurality of command objects while the input position is being continuously recognized. Subsequently, if it is judged that the input position on the contact input type monitor was located within the display areas of at least the two command objects of the plurality of command objects while the input position was being continuously recognized, at least the two command objects are selected. Next, a new command is generated based on the command assigned to each of at least the selected two command objects, and a character is instructed to execute the new command.

An example is hereinafter proposed that a battle simulation game is displayed on a contact input type monitor (e.g., a touch panel type monitor) and a player instructs a character (e.g., a tank character), which is displayed on the touch panel type monitor, to execute a command. When this case is applied to the above described program, if a player brings an instruction device (e.g., a stylus or a finger) into contact with a forward movement instruction icon (i.e., command object) displayed on a touch panel type monitor, and moves the instruction device (e.g., a stylus or a finger) from the forward movement instruction icon to a gunshot instruction icon (i.e., command object) by way of a rightward movement instruction icon (i.e., command object) while the instruction device (e.g., a stylus or a finger) is being contacted with the touch panel type monitor. Accordingly, a forward movement command assigned to the selected forward movement instruction icon, a rightward movement command assigned to the rightward movement instruction icon, and a gunshot command assigned to the gunshot instruction icon are combined, and a new command including the forward movement command, the rightward movement command, and the gunshot command is generated. Then, if the instruction device (e.g., a stylus or a finger) is lifted off the touch panel type monitor, a tank character is instructed to execute the command including the forward movement command, the rightward movement command, and the gunshot command. In other words, it is possible to move the tank character in the forward and rightward directions, and then make the tank character to fire at the enemy by sliding/stroking the instruction device (e.g., a stylus or a finger) from the forward instruction icon to the gunshot instruction icon by way of the rightward movement instruction icon and then by lifting the instruction device (e.g., a stylus or a finger) off the touch panel type monitor. Thus, it is possible to easily instruct a character (e.g., a tank character), which is displayed on a contact input type monitor (e.g., a touch panel monitor), to execute a plurality of commands.

A game program in accordance with a second aspect is the game program according to the first aspect for further implementing the following functions for the computer.

(8) A new command object display function for displaying a new command object corresponding to the new command on the contact input type monitor.

(9) A new command assignment function for assigning the new command to the new command object.

(10) A second input position judgment function for judging if the input position is located within a display area of the new command object.

According to this game program, the new command object corresponding to the new command is displayed on the contact input type monitor. Then, the new command is assigned to the new command object. Subsequently, it is judged if the input position is located within the display area of the new command object. According to this type of game, the character is instructed to execute the new command assigned to the new command object if it is judged that the input position is located within the display area of the new command object.

For example, if a player instructs a tank character displayed on a touch panel type monitor to execute a command, a new command including a forward movement command, a rightward movement command, and a gunshot command is assigned to a new command object (e.g., a combination icon) displayed on the touch panel type monitor. Then, the character is instructed to execute the forward movement command, the rightward movement command, and the gunshot command, which are assigned to the combination icon, by contacting the instruction device (e.g., a stylus or a finger) with the combination icon. Thus, it is possible to easily instruct a character (e.g., a tank character), which is displayed on a contact input type monitor (e.g., a touch panel monitor), to execute a plurality of commands.

A game program in accordance with a third aspect is the game program according to the second aspect for further implementing the following functions for the computer.

(11) A movement recognition function for judging if the input position was continuously moved within the display area of the new command object.

(12) A trajectory recognition function for recognizing a trajectory of the input position if it is judged that the input position is located within the display area of the new command object and if it is judged that the input position was continuously moved within the area of the new command object.

(13) A command change function for changing the new command assigned to the new command object to a command that is different from the new command depending on the shape of the trajectory.

According to this game program, it is judged if the input position was continuously moved within the display area of the new command object. Then, a trajectory of the input position is recognized if it is judged that the input position is located within the display area of the new command object and if it is judged that the input position was continuously moved within the display area of the new command object. Subsequently, the new command assigned to the new command object is changed to a command that is different from the new command depending on the shape of the trajectory.

For example, in a case that a player instructs a tank character displayed on a touch panel type monitor to execute a command, a trajectory of movement of an instruction device (e.g., a stylus or a finger) is recognized if the instruction device (e.g., a stylus or a finger) is moved on a combination icon displayed on the touch panel type monitor. The command including the forward movement command, the rightward movement command, and the gunshot command, which is assigned to a combination icon, is changed to a command that is different from this command depending on the shape of the trajectory. For example, if the instruction device (e.g., a stylus or a finger) is moved up and down on the combination icon a plurality of times, the command including the forward movement command, the rightward movement command, and the gunshot command is changed to a command including a backward movement command, a leftward movement command, and a gunshot command. As described above, according to the present game program, it is possible to instruct a tank character to move in an opposite direction from an instructed direction and then instruct the tank character to fire at the enemy just only by moving the instruction device (e.g., a stylus or a finger) up and down on the combination icon a plurality of times. In other words, it is possible to easily instruct a character (e.g., a tank character), which is displayed on a contact input type monitor (e.g., a touch panel type monitor), to execute a plurality of commands.

A game program in accordance with a fourth aspect is the game program according to one of the first aspect to the third aspect for further implementing the following functions for the computer.

(14) An association area setting function for setting an association area to associate at least two command objects of a plurality of command objects to the contact input type monitor.

(15) A second input position judgment function for judging if the input position is located within the association area while the input position on the contact input type monitor is being continuously recognized.

According to this game program, an association area to associate at least two command objects of a plurality of command objects is set to the contact input type monitor. Then, it is judged if the input position is located within the association area while the input position on the contact input type monitor is being continuously recognized. Subsequently, at least two command objects are selected if it is judged that the input position is located within the display areas of at least two command objects and if it is judged that the input position is located within the association area, while the input position on the contact input type monitor is being continuously recognized.

For example, a case is hereinafter assumed that a gunshot instruction icon, a forward movement instruction icon, and a rightward movement instruction icon are displayed on a touch panel type monitor to be transversely arranged in this order, and an association area is set to the contact input type monitor in the vicinity of these icons. In this case, first, an instruction device (e.g., a stylus or a finger) is contacted with the forward movement instruction icon, and then the instruction device (e.g., a stylus or a finger) is moved from the forward movement instruction icon to an association area while the instruction device (e.g., a stylus or a finger) is being contacted with the touch panel type monitor. Then, if the instruction device (e.g., a stylus or a finger) is moved from the association area to the rightward movement instruction icon, it is possible to select the forward movement instruction icon and the rightward movement instruction icon. Next the instruction device (e.g., a stylus or a finger) is moved from the rightward movement instruction icon to the association area while the instruction device (e.g., a stylus or a finger) is being contacted with the touch panel type monitor. Then, if the instruction device (e.g., a stylus or a finger) is moved from the association area to the gunshot instruction icon, it is possible to select the forward movement instruction icon, the rightward movement instruction icon, and the gunshot instruction icon. Thus, the association area is set to a different portion from the display area of the instruction icon. Therefore, even if the rightward movement instruction icon and the gunshot instruction icon are separately located, it is possible to select the gunshot instruction icon by sequentially going through the rightward movement and the association area. Accordingly, it is possible to easily instruct a character (e.g., a tank character), which is displayed on a contact input type monitor (e.g., a touch panel monitor), to execute a plurality of commands.

A game program in accordance with a fifth aspect is the game program according to one of the first aspect to the fourth aspect. In this game program, a new command is generated in the order that the input position is located within the display areas of at least the two command objects based on the command assigned to each of at least the selected two command objects. This function is implemented in a command generation function.

In this game program, for example, if a rightward movement instruction icon, a forward movement instruction icon, and a gunshot instruction icon are selected by an instruction device (e.g., a stylus or a finger) in the order of the rightward movement instruction icon, the forward movement instruction icon, and the gunshot instruction icon, a new command is generated that combines these commands in the order of the rightward movement command, the forward movement command, and the gunshot command based on each of the commands assigned to the rightward movement instruction icon, the forward movement instruction icon, and the gunshot instruction icon. Also, if a tank character is instructed to execute this new command, it is possible to move the tank character in the rightward direction and then move the tank character forward, and it is also possible to make the tank character fire at the enemy after the movement. Accordingly, it is possible to easily instruct a character (e.g., a tank character), which is displayed on a contact input type monitor (e.g., a touch panel monitor), to execute a plurality of commands. Also, it is possible to accurately instruct a character (e.g., a tank character) to execute player's predetermined thought (i.e., tactics).

A game program in accordance with a sixth aspect is the game program according to one of the first aspect to the fifth aspect. In this game program, a new command is generated depending on the number of the selected command objects in the object selection function based on the command assigned to each of at least the selected two command objects. This function is implemented in a command generation function.

In this game program, for example, if a forward movement instruction icon and a rightward movement instruction icon are selected by an instruction device (e.g., a stylus or a finger), the amount of movement that the tank character moves forward by selecting the forward movement instruction icon, and the amount of movement that the tank character moves in the rightward direction by selecting the rightward movement instruction icon are respectively changed to half thereof, and a new command to move the tank character in the forward and rightward directions by the changed amount of movement is generated. If the tank character is instructed to execute this new command, it is possible to move the tank character in the forward and rightward directions by half of the amount of forward movement performed when the forward movement instruction icon is only selected and half of the amount of rightward movement performed when the rightward movement instruction icon is only selected. Accordingly, it is possible to easily instruct a character (e.g., a tank character), which is displayed on a contact input type monitor (e.g., a touch panel monitor), to execute a plurality of commands, which are reconstructed.

A game device in accordance with a seventh aspect is a game device for implementing a game in which a plurality of command objects to instruct a character displayed on at least either of a contact input type monitor and a non-contact input type monitor to execute a command are displayed on the contact input type monitor. This game device comprises a command object display means for displaying the plurality of command objects on the contact input type monitor, a command assignment means for assigning the command to each of the plurality of command objects, an input position recognition means for recognizing an input position on the contact input type monitor based on an input signal from the contact input type monitor, the input position corresponding to the input signal, a first input position judgment means for judging if the input position is located within display areas of at least two command objects of a plurality of command objects while the input position on the contact input type monitor is being continuously recognized, an object selection means for selecting at least the two command objects if it is judged that the input position is located within the display areas of at least the two command objects of the plurality of command objects while the input position on the contact input type monitor is being continuously recognized, a command generation means for generating a new command based on the command assigned to each of at least the selected two command objects, and a new command instruction device for instructing the character to execute the new command.

A game method in accordance with a eighth aspect is a game method executed by a computer for implementing a game in which a plurality of command objects to instruct a character displayed on at least either of a contact input type monitor and a non-contact input type monitor to execute a command are displayed on the contact input type monitor. This game method comprises a command object display step for displaying the plurality of command objects on the contact input type monitor, a command assignment step for assigning the command to each of the plurality of command objects, an input position recognition step for recognizing an input position on the contact input type monitor based on an input signal from the contact input type monitor, the input position corresponding to the input signal, a first input position judgment step for judging if the input position is located within display areas of at least two command objects of a plurality of command objects while the input position on the contact input type monitor is being continuously recognized, an object selection step for selecting at least the two command objects if it is judged that the input position is located within the display areas of at least the two command objects of the plurality of command objects while the input position on the contact input type monitor is being continuously recognized, a command generation step for generating a new command based on the command assigned to each of at least the selected two command objects, and a new command instruction step for instructing the character to execute the new command.

These and other objects, features, aspects and advantages of the present invention will become apparent to those skilled in the art from the following detailed description, which, taken in conjunction with the annexed drawings, discloses a selected embodiments of the present invention.

### BRIEF DESCRIPTION OF THE DRAWINGS

Referring now to the attached drawings which form a part of this original disclosure:

FIG. 1 is an outline view of a portable game console as an example of a computer to which a game program according to the present invention can be applied.

FIG. 2 is a control block diagram as an example of the portable game console.

FIG. 3 is a functional block diagram as an example of the portable game console.

FIG. 4 is a screen shot of a command instruction that is displayed when a tank character is instructed to execute a variety of commands in a battle simulation game.

FIG. 5 is a diagram illustrating an embodiment of selecting a command icon (a first example).

FIG. 6 is a diagram illustrating an embodiment of selecting a command icon (a second example).

FIG. 7 is a diagram illustrating an embodiment of selecting a combination command icon (a first example).

FIG. 8 is a diagram illustrating an embodiment of selecting a combination command icon (a second example).

FIG. 9 is a diagram illustrating another embodiment of selecting a combination command icon (a second example).

FIG. 10 is a flowchart 1 for illustrating an outline of a variety of processing performed in a command instruction system.

FIG. 11 is a flowchart 2 for illustrating an outline of a variety of processing performed in a command instruction system.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

Configuration of Game Device

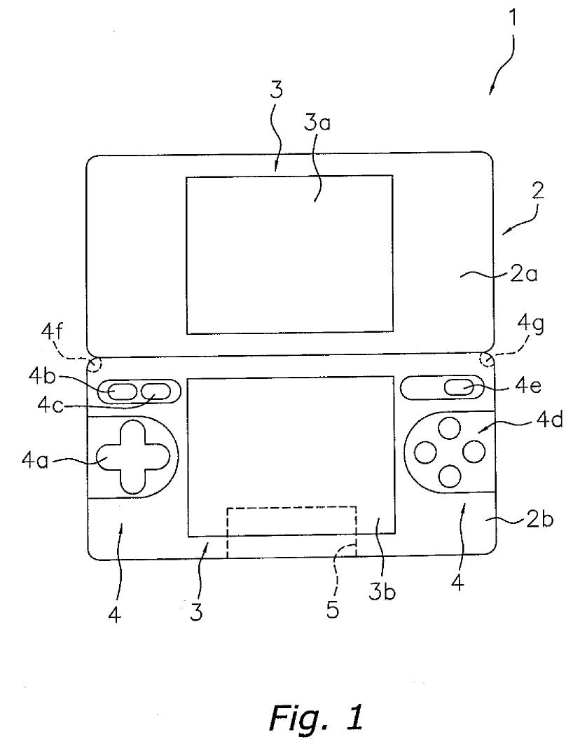

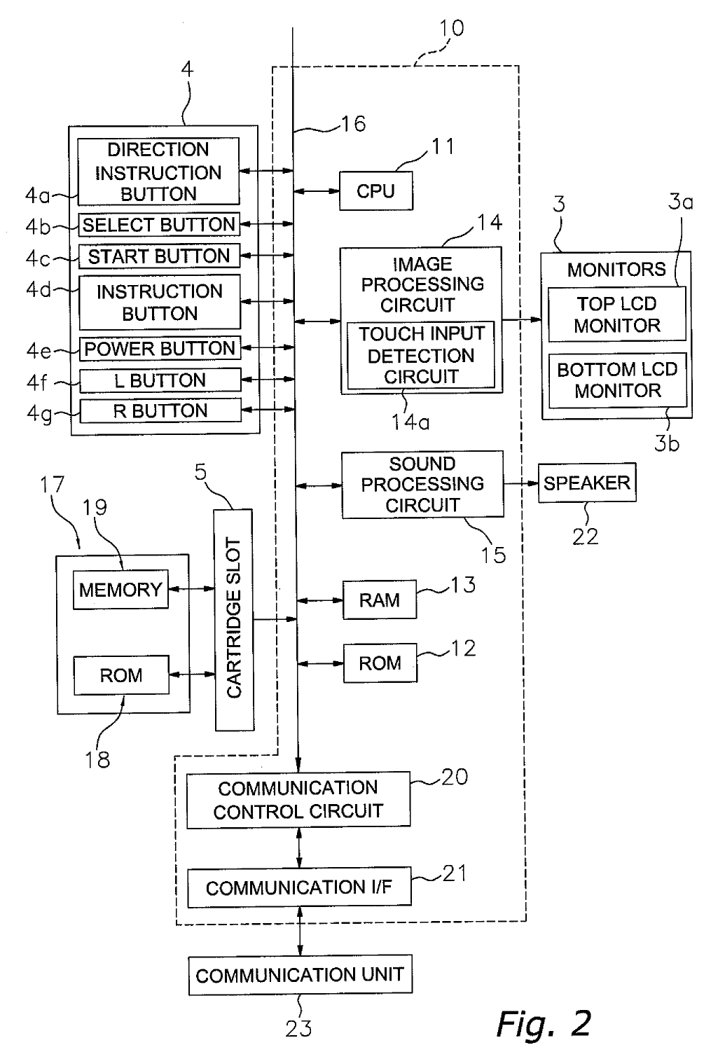

FIG. 1 is an outline view of a portable game console 1 as an example of a computer to which a game program in accordance with the present invention can be applied. Also, FIG. 2 is a control block diagram as an example of the portable game console 1.

As shown in FIGS. 1 and 2, the portable game console 1 is mainly comprised of a core unit 2, a liquid crystal device (LCD) monitor unit 3, an input unit 4, a cartridge slot 5, and a communication unit 23. The core unit 2 includes a top chassis 2a and a bottom chassis 2b. The top chassis 2a and the bottom chassis 2b are openably/closably connected to each other. The LCD monitor unit 3 is comprised of a first LCD monitor 3a provided in the top chassis 2a (i.e., a top LCD monitor 3a) and a second LCD monitor 3b provided in the bottom chassis 2b (i.e., a bottom LCD monitor 3b). Here, for example, the top LCD monitor 3a is a non-contact input type monitor (i.e., a non-touch panel type monitor), and the bottom LCD monitor 3b is a contact input type monitor (i.e., a touch panel type monitor). The non-touch panel type monitor has a LCD panel, and the touch panel type monitor has a LCD panel and a touch panel. In the touch panel type monitor, a screen surface of the LCD panel and a data input surface of the touch panel are integrally formed to be laminated one above the other. The input unit 4 includes a cross-shape direction instruction button 4a that is arranged in the central portion of the left side of the bottom chassis 2b, a select button 4b and a start button 4c that are arranged right and left in the upper portion of the left side of the bottom chassis 2b, instruction buttons 4d that are arranged in the central portion of the right side of the bottom chassis 2b, a power button 4e that is arranged in the upper portion of the right side of the bottom chassis 2b, and a L button 4f and a R button 4g that are respectively arranged in the right and left corners of the bottom chassis 2b. The cartridge slot 5 is provided in the bottom portion of the bottom chassis 2b. For example, it is possible to attach a video game cartridge to the cartridge slot 5. The communication unit 23 is incorporated in the core unit 2 (e.g., the top chassis 2a). The communication unit 23 is provided with functions, such as the local wireless network function and the internet connection function with the wireless LAN. The game console 1 is provided with a volume adjustment button, an earphone jack, and the like. However, since these features are well known an explanation of these members will be hereinafter omitted.

As shown in FIG. 2, the portable game console 1 includes a control unit (i.e., a control unit 10) in its inside. The control unit 10 includes a central processing unit (CPU) 11 in which a micro processor is used, a read only memory (ROM) 12 functioning as a main storage unit, a random access memory (RAM) 13, an image processing circuit 14, a sound processing circuit 15, a communication control circuit 20, and a communication interface 21. These units or members are connected to each other through a bus 16.

The CPU 11 interprets a command from a game program and performs a variety of data processing and data control. The ROM 12 stores a program necessary for the basic control (e.g., activation control) of the game console 1, and the like. The RAM 13 secures a work area with respect to the CPU 11. The image processing circuit 14 controls the LCD monitor unit 3 depending on a drawing instruction from the CPU 11, and displays a predetermined image on at least one of the top LCD monitor 3a and the bottom LCD monitor 3b. Also, the image processing circuit 14 includes a touch input detection circuit 14a. When an instruction device (e.g., a stylus or a finger) directly contacts the touch panel, the coordinate data of the contact position is provided from the touch input detection circuit 14a to the CPU 1, and the contact position is recognized by the CPU 11. Also, when an instruction device is directly contacted with the touch panel in a position of an object displayed on the LCD panel, the coordinate data of the object is provided from the touch input detection circuit 14a to the CPU 11, and then the object is recognized by the CPU. The sound processing circuit 15 generates an analogue audio signal depending on a sound producing instruction by the CPU 11, and then outputs the signal to a speaker 22. The communication control circuit 20 is included in the communication unit 23. It is used for wirelessly connecting the game console 1 to another game console and the like. The communication control unit 20 is connected to the CPU 11 through the bus 16. The communication control circuit 20 controls and transmits a connection signal for connecting the game console 1 to the internet with the local wireless network or the wireless LAN.

The external storage device 17, which is separately formed from the control unit 10, is connected to the bus 16. For example, the external storage device 17 includes a game cartridge or the like, which are detachably attached to the core unit 2 (e.g., the bottom chassis 2b). A ROM 18 functioning as a storage medium and a memory 19 functioning as a rewritable user memory are provided in the inside of the external storage device 17. A game program for allowing the game console 1 to function as a computer and a variety of data necessary for running the game program are preliminarily stored in the ROM 18. The variety of data include a variety of image data and the like. A rewritable memory (e.g., a flash memory) is used as the memory 19. The game save data and the like are stored in the memory 19 as needed. Note that not only a semiconductor storage device but also a variety of storage medium, such as a magnetic storage media, an optical storage media, and a magneto optical storage media, may be used as the storage media of the external storage device 17. Also, note that an interface circuit is provided between the bus 16 and each of the elements as needed. However, illustration of these elements is hereinafter omitted.

In the game console 1 with the above described configuration, a game program stored in the ROM 18 of the external storage device 17 is loaded, and the loaded game program is executed by the CPU 11. Accordingly, a player can play various genres of games displayed on the LCD monitor unit 3. Also, the game console 1 is connected to the wireless network through the communication control unit 20 and/or connected to other game console(s) through a communication cable and the like. Accordingly, it is possible to perform data transfer between the game console 1 and other game console(s) and perform a versus-type game.

Explanation of Various Means in the Game Device

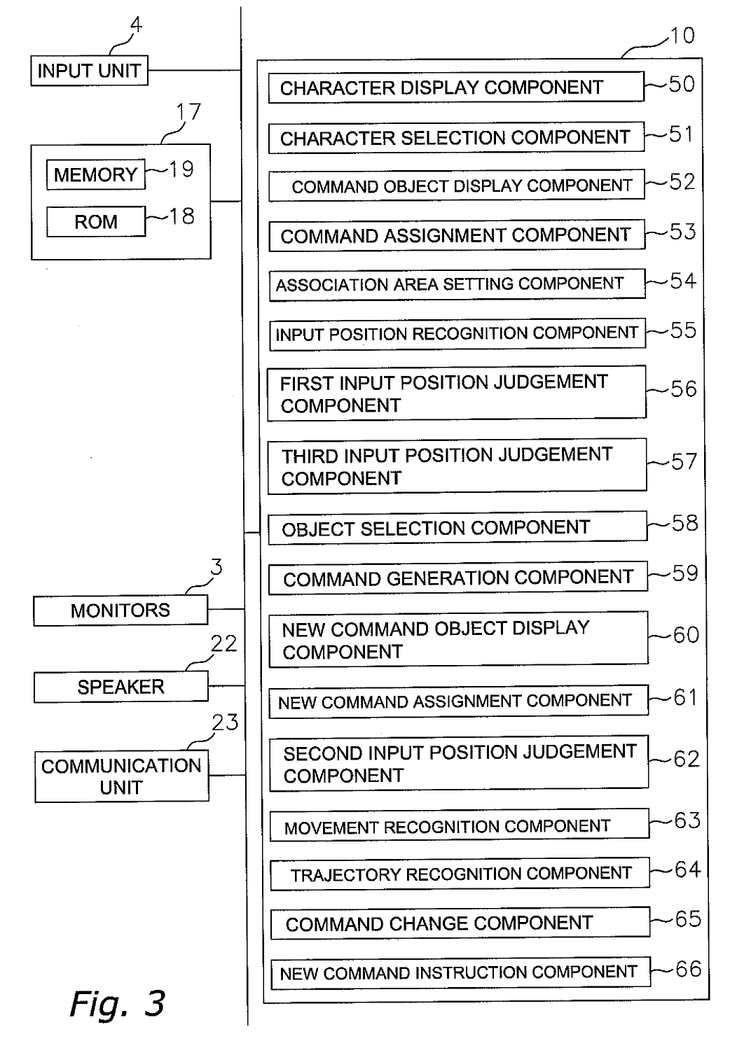

A game executed in the game console 1 is a battle simulation game, for instance. In the game console 1, a plurality of command objects (e.g., command icons) are configured to be displayed on the bottom LCD monitor 3b. Here, the plurality of command objects serve to instruct a character (e.g., a tank character) displayed on at least one of the contact input type monitor (i.e., the bottom LCD monitor 3b of the LCD monitor unit 3) and the non-contact input type monitor (i.e., the top LCD monitor 3a of the LCD monitor unit 3) to execute a command. FIG. 3 is a functional block diagram for explaining a variety of functions of a command instruction system that plays a main role in the present invention. Here, a variety of functions of the command instruction system are performed in a battle simulation game to be hereinafter described, for instance.

A character display component 50 has a function of displaying a tank character on the bottom LCD monitor 3b.

In the character display component 50, a tank character is displayed on the bottom LCD monitor 3b. Here, when the game program is loaded, the tank image data corresponding to a tank character is provided from the external memory unit 17 (e.g., the ROM 18) to a control unit 10 (e.g., the RAM 13) and is stored in the RAM 13. Then, the initial coordinate data of the tank coordinate data for displaying the tank image data on the bottom LCD monitor 3b is provided from the external memory unit 17 (e.g., the ROM 18) to a control unit 10 (e.g., the RAM 13) and is stored in the RAM 13. Here, the tank image data and the tank coordinate date are recognized by the control unit 10 (e.g., the CPU 11). Then, the tank image data stored in the RAM 13 is provided to the bottom LCD monitor 3b through the image processing circuit 14, based on the instruction by the CPU 11. Next, the tank image data is displayed on a predetermined position of the bottom LCD monitor 3b based on the tank coordinate data.

A character selection component 51 has a function of judging if an input position is located within a display area of the tank character on the monitor 3 and then selecting a tank character if it is judged that the input position is located within the display area of the tank character. In the character selection component 51, when the control unit 10 judges that the input position is located within the display area of a tank character on the monitor 3, the tank character is selected by the control unit 10.

In the character selection component 51, the control unit 10 judges if a position in which an instruction device (e.g., a stylus or a finger) is contacted with the bottom LCD monitor 3b is located within the display area of a tank character on the monitor 3. Then, if the control unit 10 (e.g., the CPU 11) judges that the position in which the instruction device contacts the monitor 3 is located within the display area of the tank character on the monitor 3, the tank character is selected by the control unit 10 (e.g., the CPU 11).

Specifically, the position coordinate data, which indicates the position in which the instruction device contacts the touch panel of the bottom LCD monitor 3b, is provided from the touch input detection circuit 14a to the CPU 11, and is recognized by the CPU 11. Next, the CPU 11 judges if the position coordinate data of the instruction device, which were recognized by the CPU 11, is located within the display area of the tank character on the monitor. Next, if the CPU 11 judges that the position coordinate data of the instruction device is located within the display area of the tank character on the monitor 3, the tank character is recognized and selected by the CPU 11.

A command object display component 52 has a function of displaying a plurality of command icons 71 on the bottom LCD monitor 3b.

Here, when a game program is loaded, command icon image data corresponding to the command icons 71 is provided from the external memory unit 17 (e.g., the ROM 18) to the control unit 10 (e.g., the RAM 13) and is stored in the RAM 13. Then, command icon coordinate data for displaying the command icon image data on the bottom LCD monitor 3b is provided from the external memory unit 17 (e.g., the ROM 18) to the control unit 10 (e.g., the RAM 13) and is stored in the RAM 13. At this time, the command icon image data and the command icon coordinate date are recognized by the control unit 10 (e.g., the CPU 11). Then, the command icon image data stored in the RAM 13 is provided to the bottom LCD monitor 3b through the image processing circuit 14 based on the instruction by the CPU 11. Next, the command icon image data is displayed on a predetermined position of the bottom LCD monitor 3b based on the command icon coordinate data. At this time, position coordinate data in the inside of the command icon image data displayed on the bottom LCD monitor 3b is recognized by the control unit 10 (e.g., the CPU 11). Accordingly, the display area of the command icon is recognized by the control unit 10.

A command assignment component 53 has a function of assigning a command to each of the command icons 71.

When a game program is loaded, a command is provided from the external memory unit 17 (e.g., the ROM 18) to the control unit 10 (e.g., the RAM 13) and is stored in the RAM 13. At this time, the command stored in the RAM 13 is recognized by the CPU 11. Then, the command recognized by the CPU 11 is assigned to each of the command icons 71 based on the instruction by the CPU 11. Correspondence between a command and a command icon 71 to which the command is assigned is preset in the game program.

An association area setting component 54 has a function of setting an association area to associate at least two command icons of the command icons 71 to the contact input type monitor 36.

In the association rear setting component 54, the association area to associate at least two command icons 71 of the command icons 71 is set to the bottom LCD monitor 3b by the control unit 10 (e.g., the CPU 11) and is recognized by the control unit 10 (e.g., the CPU 11).

An input position recognition component 55 has a function of recognizing an input position on the bottom LCD monitor 3b corresponding to an input signal from the bottom LCD monitor 3b based on the input signal.

In the input position recognition component 55, an input signal from the touch panel of the bottom LCD monitor 3b is sent when the instruction device contacts the bottom LCD monitor 3b. Accordingly, a position in which the instruction device contacts the touch panel of the bottom LCD monitor 3b is recognized by the control unit 10 (e.g., the CPU 11). Specifically, the position coordinate data of the position where the instruction device contacts the touch panel of the bottom LCD monitor 3b is provided from the touch input detection circuit 14a to the control unit 10 (e.g., the CPU 11) and is recognized by the control unit 10 (e.g., the CPU 11).

A first input position judgment component 56 has a function of judging if an input position on the bottom LCD monitor 3b is located within the display areas of at least two command icons 71 of the command icons 71 on the monitor 3 while the input position is being continuously recognized. In the first input position judgment component 56, the control unit 10 judges if the input position is located within the display areas of at least two command icons 71 of the command icons 71 on the monitor 3 while the input position on the bottom LCD monitor 3b is being continuously recognized by the control unit 10.

In first input position judgement component 56, the control unit 10 judges if the position where the instruction device contacts the monitor 3 is located within the display areas of at least two command icons 71 of the command icons 71, while the position where the instruction device contacts the bottom LCD monitor 3b is being continuously recognized by the control unit 10, i.e., while the instruction device is being continuously contacted with the bottom LCD monitor 3b. Specifically, the position coordinate data, which indicates the position in which the instruction device contacts the touch panel of the bottom LCD monitor 3b, is provided from the touch input detection circuit 14a to the control unit 10 (e.g., the CPU 11), and is recognized by the control unit 10 (e.g., the CPU 11). Then, the control unit 10 judges if the position coordinate data of the instruction device, which was recognized by the control unit 10, is located within the display areas of at least two command icons 71, which was recognized by the control unit 10.

A third input position judgment component 57 has a function of judging if an input position on the contact input type monitor 36 is located within the association area while the input position is being continuously recognized.

In the third input position judgment component 57, the control unit 10 judges if the position in which the instruction device contacts the bottom LCD monitor 3b is located within the association area, while the position in which the instruction device contacts the bottom LCD monitor 3b is being continuously recognized by the control unit 10, i.e., while the instruction device is being continuously contacted with the bottom LCD monitor 3b. Specifically, the position coordinate data, which indicates the position in which an instruction device contacts the touch panel of the bottom LCD monitor 3b, is provided from the touch input detection circuit 14a to the control unit 10 (e.g., the CPU 11), and is recognized by the control unit 10 (e.g., the CPU 11). Then, the control unit 10 judges if the position coordinate data of the instruction device, which was recognized by the CPU 10, is located within the association area recognized by the control unit 10.

An object selection component 58 has a function of selecting at least two command icons 71 if an input position on the bottom LCD monitor 3b is located within the display areas of the at least two command icons 71 of the command icons 71 and if the input position is located within the association area, while the input position is being continuously recognized. In the object selection component 58, at least two command icons 71 are selected by the control unit 10 if the control unit 10 judges that the input position on the bottom LCD monitor 3b was located within the display areas of the at least two command icons and judges that the input position was located within the association area while the input position was being continuously recognized.

In the object selection component 58, if the control unit 10 (e.g., the CPU 11) judges that the instruction device was located within the display areas of the at least two command icons 71 of the command icons 71 and judges that the position in which the instruction device was located within the association area, while the position in which the instruction device is contacted with the bottom LCD monitor 3b was being continuously recognized by the control unit 10, i.e., while the instruction device was being continuously contacted with the bottom LCD monitor 3b, the at least two command icons 71 are recognized and selected by the control unit 10 (e.g., the CPU 11).

Specifically, the position coordinate data, which indicates the position in which the instruction device is contacted with the touch panel of the bottom LCD monitor 3b, is provided from the touch input detection circuit 14a to the CPU 11, and is recognized by the CPU 11. Then, if the CPU 11 judges that the position coordinate data of the instruction device recognized by the CPU 11 is located within the display areas of the at least two command icons 71 recognized by the CPU 11, and if the CPU 11 judges that the position coordinate data of the instruction device recognized by the CPU 11 is located within the association area recognized by the CPU 11, at least two command icons 71 are recognized and selected by the CPU 11.

A command generation component 59 has a function of generating a new command based on a command assigned to each of at least two selected command icons 71. Also, in the command generation component 59, a new command is generated based on the command assigned to each of the at least two selected command icons 71 in the order that the input position was located within the display areas of the at least two command icons 71. Furthermore, in the command generation component 59, a new command is generated based on the command assigned to each of the at least two selected command icons 71 depending on the number of the selected command icons 71 in the object selection component 58.

In the command generation component 59, a new command (e.g., a combination command) is generated by the control unit 10 (e.g., the CPU 11) based on the command assigned to each of the at least two selected command icons 71 by the control unit 10 (e.g., the CPU 11). At this time, an order in which an input position (i.e., a position in which the instruction device contacts the monitor 3) was located within the display areas of at least two command icons 71 is recognized by the control unit 10 (e.g., the CPU 11), and a new command (e.g., a combination command) is generated by the control unit 10 (e.g., the CPU 11) based on the command assigned to each of the at least two selected command icons 71 by the control unit 10 (e.g., the CPU 11). Also, a new command (e.g., a combination command) is generated by the control unit 10 (e.g., the CPU 11) based on the command assigned to each of the at least two selected command icons 71 depending on the number of the command icons 71 selected by the control unit 10 (e.g., the CPU 11).

A new command object display component 60 has a function of displaying a new command icon 71 corresponding to a new command (e.g. a combination command) on the bottom LCD monitor 3b.

Here, new command icon image data corresponding to the new command icon 71 is provided from the external memory unit 17 (e.g., the ROM 18) to the control unit 10 (e.g., the RAM 13), and is stored in the RAM 13. Then, new command icon coordinate data for displaying the new command icon image data on the bottom LCD monitor 3b is computed by the control unit 10 (e.g., the CPU 11) and is stored in the RAM 13. At this time, the new command icon image data and the new command icon coordinate date are recognized by the control unit 10 (e.g., the CPU 11). Then, the new command icon image data stored in the RAM 13 is provided to the bottom LCD monitor 3b through the image processing circuit 14 based on the instruction by the CPU 11. Next, the new command icon image data is displayed on the bottom LCD monitor 3b based on the new command icon coordinate data. At this time, a plurality of position coordinate data in the inside of the command icon image data displayed on the bottom LCD monitor 3b is recognized by the control unit 10 (e.g., the CPU 11). Accordingly, the display area of the new command icon is recognized by the control unit 10.

A new command assignment component 61 has a function of assigning a new command (e.g., a combination command) to a new command icon.

In the new command assignment component 61, a new command (e.g., a combination command) generated by the control unit 10 (e.g., the CPU 11) is assigned to a new command icon 71 displayed on the bottom LCD monitor 3b, based on the instruction by the CPU 11.

A second input position judgment component 62 has a function of judging if an input position is located within the display area of a new command icon 71.

In the second input position judgment component 62, the control unit 10 (e.g., the CPU 11) judges if a position in which the instruction device contacts the bottom LCD monitor 3b is located within the display area of the new command icon 71. Specifically, the position coordinate data, which indicates the position in which the instruction device contacts the touch panel of the bottom LCD monitor 3b, is provided from the touch input detection circuit 14a to the control unit 10 (e.g., the CPU 11), and is recognized by the control unit 10 (e.g., the CPU 11). Then, the control unit 10 judges if the position coordinate data of the instruction device, which was recognized by the CPU 10, is located within the display areas of the new command icon 71 recognized by the control unit 10.

A movement recognition component 63 has a function of judging if an input position was continuously moved within the display area of a new command icon 71. In the movement recognition component 63, the control unit 10 judges if the input position was continuously moved within the display area of the new command icon.

In the movement recognition component 63, the control unit 10 judges if the position in which the instruction device contacts the bottom LCD monitor 3b is continuously recognized within the display area of the new command icon 71 by the control unit 10. Specifically, the position coordinate data, which indicates the position in which the instruction device contacts the touch panel of the bottom LCD monitor 3b, is provided from the touch input detection circuit 14a to the CPU 11, and is recognized by the CPU 11. Then, the control unit 10 judges if the position coordinate data of the instruction device, which was recognized by the CPU 11, is continuously recognized by the control unit 10 within the display areas of the new command icon 71 recognized by the CPU 11.

A trajectory recognition component 64 has a function of recognizing a trajectory of an input position if it is judged that the input position is located within the display area of a new command icon 71 and if it is judged that the input position was continuously moved within the display area of the new command icon.

In the trajectory recognition component 64, if the control unit 10 judges that the position in which the instruction device contacts the bottom LCD monitor 3b is located within the display area of the new command icon 71, and judges that the position in which the instruction device contacts the bottom LCD monitor 3b is being continuously recognized by the control unit 10 within the display area of the new command icon 71, the shape of the trajectory of the input position is recognized by the control unit 10 (e.g., the CPU 11).

A command change component 65 has a function of changing a new command assigned to a new command icon to a command that is different from the new command depending on the shape of the trajectory.

In the command change component 65, a new command (e.g., a combination command) assigned to a new command icon 71 is changed to a command that is different from the combination command by the control unit 10 (e.g., the CPU 11) depending on the shape of the trajectory recognized by the control unit 10 (e.g., the CPU 11). Correspondence between the shape of a trajectory and a different command changed depending on the shape of the trajectory is preset in the game program.

A new command instruction component 66 has a function of instructing the character to execute a new command. In the new command instruction component 66, the control unit 10 instructs the character to execute a new command generated by the control unit 10.

In the new command instruction component 66, a new command (e.g., a combination command) generated by the control unit 10 (e.g., the CPU 11) is recognized by the CPU 11, and the character is instructed to execute the new command (e.g., a combination command) recognized by the control unit 10 (e.g., the CPU 11).

In the new command instruction component 66, if the control unit 10 (e.g., the CPU 11) judges that the input position is located within the display area of the new command icon 71, the character is instructed to execute the new command assigned to the new command icon 71 based on the instruction of the control unit 10 (e.g., the CPU 11). For example, if the CPU 11 judges that the position in which the instruction device contacts the monitor is located within the display area of the new command icon 71, the character is instructed to execute the new command (e.g., a combination command) assigned to the new command icon 71 based on the instruction of the CPU 11. Specifically, if the control unit 10 judges that the position coordinate data of the instruction device is located within the display area of the new command icon recognized by the control unit 10, the character is instructed to execute the new command (e.g., a combination command) assigned to the new command icon 71 based on the instruction by the CPU 11.

More specifically, if the control unit 10 (e.g., the CPU 11) judges that the input position is located within the display area of the new command icon 71, and if the control unit 10 (e.g., the CPU 11) does not judge that the input position continuously moves within the display area of the new command icon 71, a character is instructed to execute the new command assigned to the new command icon 71 based on the instruction by the control unit 10 (e.g., the CPU 11). For example, if the control unit 10 judges that the position where the instruction device contacts the bottom LCD monitor 3b is located within the display area of the new command icon 71, and if the position where the instruction device contacts the bottom LCD monitor 3b is not continuously recognized by the control unit 10 within the display area of the new command icon 71, a tank character is instructed to execute the new command (e.g., a combination command) assigned to the new command icon 71 based on the instruction by the control unit 10 (e.g., the CPU 11).

In addition, if the control unit 10 (e.g., the CPU 11) judges that the input position is located within the display area of the new command icon 71, and judges that the input position was continuously moved within the display area of the new command icon 71, a character is instructed to execute a command that is assigned to the new command icon 71 and is different from the new command based on the instruction by the control unit 10 (e.g., the CPU 11). For example, if the control unit 10 judges that the position where the instruction device contacts the bottom LCD monitor 3b is located within the display area of the new command icon 71, and if the position where the instruction device contacts the bottom LCD monitor 3b is being continuously recognized by the control unit 10 within the display area of the new command icon 71, a tank character is instructed to execute a command that is assigned to the new command icon 71 and is different from the new command (e.g., the combination command) based on the instruction by the control unit 10 (e.g., the CPU 11).

Summary of Command Instruction System in Battle Simulation Game

Next, the content of a command instruction system performed, for instance, in a battle simulation game will be hereinafter specifically explained. The command instruction system serves as a system of instructing a character (e.g., a tank character) to execute a variety of commands. The command instruction system is implemented by the above described components and devices.

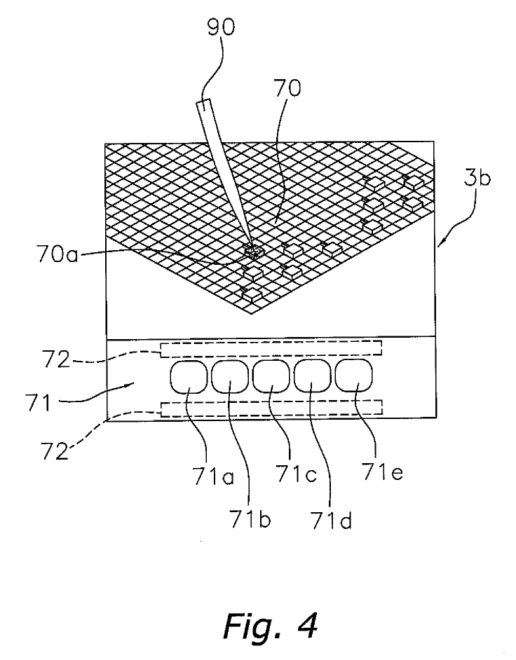

FIG. 4 is a screen shot of a command instruction, which is displayed when a tank character is instructed to execute a variety of commands. The screen shot is displayed on the bottom LCD monitor 3b.

A screen shot of the layout of a plurality of tank characters 70 is displayed on the upper portion of the bottom LCD monitor 3b. A plurality of squares formed by a plurality of grid lines and a plurality of tank characters 70 arranged on the squares are displayed in the screen shot of the layout.

The command icons 71 for instructing a tank character 70 to execute a variety of commands are displayed on the lower portion of the bottom LCD monitor 3b. Association areas 72 for associating at least two command icons 71 of the command icons 71 are provided above and below the command icons 71 on the lower portion of the bottom LCD monitor 3b. An input position within a setting area of each of the association areas 72 on the bottom LCD monitor 3b, in other words, a position where the instruction device 90 contacts the monitor 3, is recognized by the control unit 10 (e.g., the CPU 11). The association areas 72 are configured not to be displayed on the bottom LCD monitor 3b, however, it will be apparent to one of ordinary skill in the art from this disclosure that the association areas 72 may be configured to be displayed on the bottom LCD monitor 3b.

The command icons 71 are laterally arranged on the bottom LCD monitor 3b and include a 6-squares forward movement instruction icon 71a, a 6-squares backward movement instruction icon 71b, a 4-squares rightward movement instruction icon 71c, a 4-squares leftward movement instruction icon 71d, and a gunshot instruction icon 71e. A command to move the tank character 70 forward by 6 squares, a command to move the tank character 70 backward by 6 squares, a command to move the tank character 70 in the rightward direction by 4 squares, a command to move a tank character 70 in the leftward direction by 4 squares, and a command to make the tank character fire at the enemy, are respectively assigned to the 6-squares forward movement instruction icon 71a, the 6-squares backward movement instruction icon 71b, the 4-squares rightward movement instruction icon 71c, the 4-squares leftward movement instruction icon 71d, and the gunshot instruction icon 71e.

As shown in FIG. 4, in the present battle simulation game in which the tank characters 70 and the command icons 71 are displayed on the bottom LCD monitor 3b, if the stylus 90, for example, is located within the display area of a tank character 70a displayed on the monitor, in other words, if the stylus 90 contacts a portion of the bottom LCD monitor 3b in which the tank character 70a is displayed, the tank character 70a that is an object to be instructed to execute a command is selected. Here, if the stylus 90 is continuously located within the display area of the tank characters 70 displayed on the monitor, in other words, if the stylus 90 continuously contacts portions of the bottom LCD monitor 3b in which the tank characters 70 are displayed, the tank characters 70 with which the stylus 90 continuously contacts are selected.

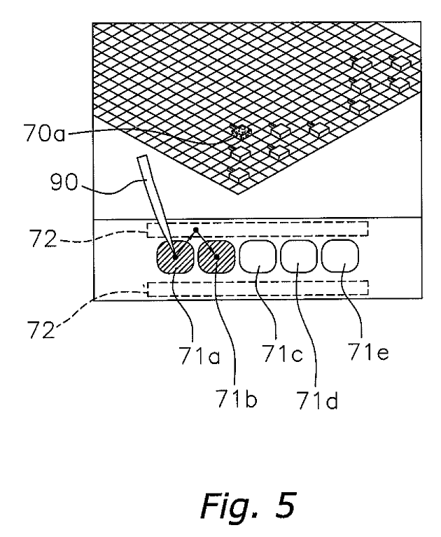

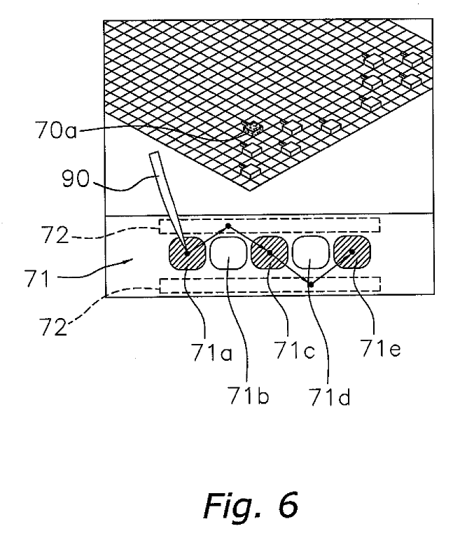

Then, as shown in FIGS. 5 and 6, in a state that the tank character 70a is being selected, the command icons 71 in which the stylus 90 was located are selected if the following steps are sequentially performed: the stylus 90 is located within the display area of one of the command icons 71 displayed on the monitor 3; and then the stylus 90 is moved to either of the association areas 72 located above and below the command icons 71 while the stylus 90 contacts the bottom LCD monitor 3b; and finally the stylus 90 is located within the display area of the other command icon 71 displayed on the monitor while the stylus 90 contacts the bottom LCD monitor 3b.

A first example of the above described case is shown in FIG. 5. As shown in FIG. 5, if the stylus 90 is firstly located within the display area of the 6-squares forward movement instruction icon 71a, and then the stylus 90 is moved to the association area 72 located above the command icons 71 while the stylus 90 contacts the bottom LCD monitor 3b, and furthermore, the stylus 90 is moved to the inside of the display area of the 4-squares rightward movement instruction icon 71c, the 6-squares forward movement instruction icon 71a and the 4-squares rightward movement instruction icon 71c are selected, both of which the stylus 90 was located in.

The second example of the above described case is shown in FIG. 6. As shown in FIG. 6, the stylus 90 is firstly located within the display area of the 6-squares forward movement instruction icon 71a, and then the stylus 90 is moved to the association area 72 located above the command icons 71 while the stylus 90 contacts the bottom LCD monitor 3b, and furthermore the stylus 90 is moved to the inside of the display area of the 4-squares rightward movement instruction icon 71c while the stylus 90 contacts the bottom LCD monitor 3b. Next, the stylus 90 is moved to the association area 72 located below the command icons 71 while the stylus 90 contacts the bottom LCD monitor 3b. Finally, the stylus 90 is moved to the inside of the display area of the gunshot instruction icon 71e while the stylus 90 contacts the bottom LCD monitor 3b. Accordingly, the 6-squares forward movement instruction icon 71a, the 4-squares rightward movement instruction icon 71c, and the gunshot instruction icon 71e are selected, all of which the stylus 90 was located in.

If the desired command icons 71 are selected as the above described two examples, the commands assigned to the selected command icons 71 are combined, and a combination command is generated. At this time, the command assigned to the selected command icon 71 is changed by the control unit (e.g., the CPU 11) depending on the number of the selected command icons. For example, the amount of movement in the movement instruction command assigned to the movement instruction icon is configured to be divided by the number of the selected command icons 71. Note that a remainder left by dividing the amount of movement by the number of the command icons is discarded. In other words, the quotient is rounded down or truncated to a whole number. Also, commands assigned to the changed command icons 71 are combined by the control unit (e.g., the CPU 11), and the combined command is recognized as a new command by the control unit (e.g., the CPU 11). At this time, the order in which command icons 71 are selected, in other words, the order of the commands assigned to the command icons, is recognized by the CPU 11.

For example, in the case of the above described first example in FIG. 5, the number of the selected command icons 71 is two. Accordingly, the 6-squares forward movement instruction command and the 4-squares rightward movement instruction command are changed to a 3-squares (=|6 squares/2 (the number of command icons)|) forward movement instruction command and a two-squares (=|4 squares/2 (the number of command icons)|) rightward movement instruction command, respectively. Also, in this case, the 6-squares forward movement instruction icon 71a and the 4-squares rightward movement instruction icon 71c are selected in the order of the 6-squares forward movement instruction icon 71a and the 4-squares rightward movement instruction icon 71c. Accordingly, the commands assigned to the command icons 71 are combined by the control unit (e.g., the CPU 11) in the order of the 3-squares forward movement instruction command and the 2-squares rightward movement instruction command, and the combined commands are recognized as a combination command by the control unit (e.g., the CPU 11).

In the case of the above described second example in FIG. 6, the number of the selected command icons 71 is three. Accordingly, the 6-squares forward movement instruction command and the 4-squares rightward movement instruction command are changed to a 2-squares (=|6 squares/3 (the number of command icons)|) forward movement instruction command and a 1-square (=|4 squares/3 (the number of command icons)|) rightward movement instruction command, respectively. Also, in this case, the 6-squares forward movement instruction icon 71a, the 4-squares rightward movement instruction icon 71c, and the gunshot instruction icon 71e are selected in the order of the 6-squares forward movement instruction icon 71a, the 4-squares rightward movement instruction icon 71c, and the gunshot instruction icon 71e. Accordingly, the commands assigned to the command icons are combined by the control unit (e.g., the CPU 11) in the order of the 2-squares forward movement instruction command, the 1-square rightward movement instruction command, and the gunshot instruction command, and the combined commands are recognized as a combination command by the control unit (e.g., the CPU 11).

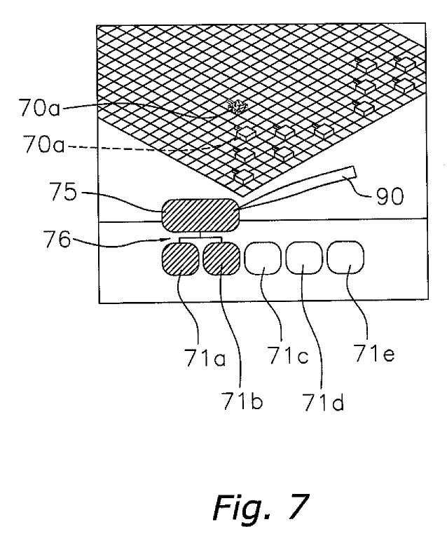

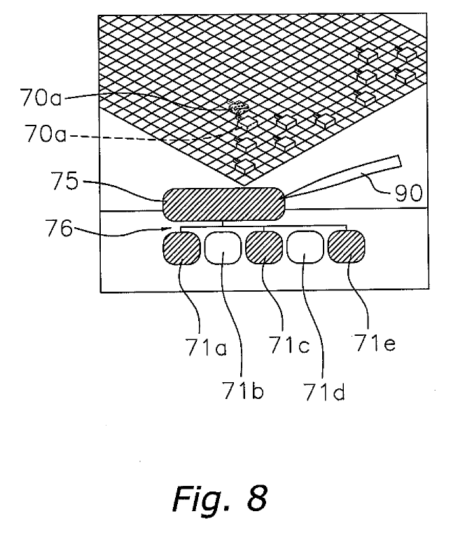

As shown in FIG. 7 (corresponding to the first example in FIG. 5) and FIG. 8 (corresponding to the second example in FIG. 6), a combination command icon 75 is displayed on the bottom LCD monitor 3b. Then, a combination command is assigned to the combined command icon 75. Here, the combination command icon 75 is arranged above the command icons 71 and displayed on the bottom LCD monitor 3b. The combination command icon 75 is configured to be displayed on the bottom LCD monitor 3b while the size thereof is configured to be changed depending on the number of the selected command icons 71. Also, a lead line (i.e., a link line 76) extending from the combination command icon 75 to the selected command icons 71 is displayed on the bottom LCD monitor 3b. Displaying the link line 76 on the monitor allows a player to see which command icons 71 were selected to generate the combination command.

Then, if the stylus 90 is once located within the display area of the combination command icon 75 and then lifted off the display area of the combination command icon 75, the tank character 70a is instructed to execute the combination command assigned to the combination command icon 75.

As shown in FIG. 7, in the case of the above described first example in FIG. 5, if the stylus 90 is once located within the display area of the combination command icon 75 and then lifted off the display area of the combination command icon 75, the tank character 70a is moved forward by three squares and then moved in the rightward direction by two squares.

As shown in FIG. 8, in the case of the above described second example in FIG. 6, if the stylus 90 is once located within the display area of the combination command icon 75 and then lifted off the display area of the combination command icon 75, the tank character 70a is sequentially allowed moved forward by two squares, moved rightward by one square, and fires at the enemy.

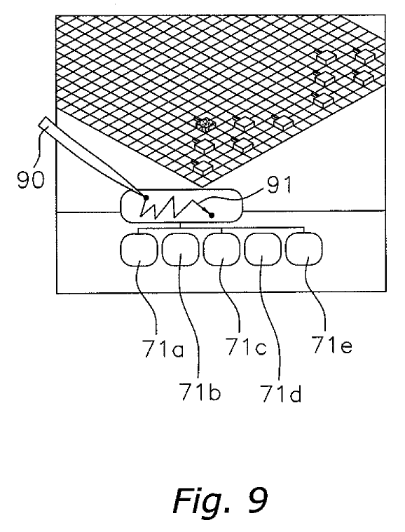

On the other hand, as shown in FIG. 9, if the stylus 90 is moved within the display area of the combination command icon 75 while the stylus 90 is located within the display area of the combination command icon 75, a trajectory of the contact position of the stylus 90 (i.e., the shape of the trajectory) is recognized by the control unit (e.g., the CPU 11). Accordingly, depending on the shape of the trajectory, the combination command assigned to the combination command icon 75 is changed to a command that is different from the combination command by the control unit (e.g., the CPU 11). Then, if the stylus 90 is lifted off the display area of the combination command icon 75, the tank character 70a is instructed to execute the command that is different from the combination command, based on the instruction by the CPU 11.

For example, as shown in FIG. 9, if the stylus 90 is moved up and down a plurality of times within the display area of the combination command icon 75, the trajectory 91 of the contact position of the stylus 90 is formed in a jagged shape including six pointed portions. Accordingly, the above described combination command is changed to a command that corresponds to the shape of the trajectory 91 and is different from the combination command. For example, the jagged shape 91 corresponds to a command for canceling a command that the tank character 70a is instructed to execute. Accordingly, the above described combination command is changed to a command cancel command. Then, if the stylus 90 is lifted off the display area of the combination command icon 75, the tank character 70a is instructed to execute the command cancel command based on the instruction by the control unit (e.g., the CPU 11). In other words, the combination command generated by selecting the command icons 71 is canceled. An example in which a command that is different from the combination command is changed to a predetermined command (command cancel command) is preset in the game program depending on the shape of the trajectory. However, it will be apparent to one of ordinary skill in the art from this disclosure that a command that is different from the combination command may be selected from a plurality of commands prepared in the game program and may be configured to be changed according to the shape of the trajectory.

Process Flow of Command Instruction System in Battle Simulation Game

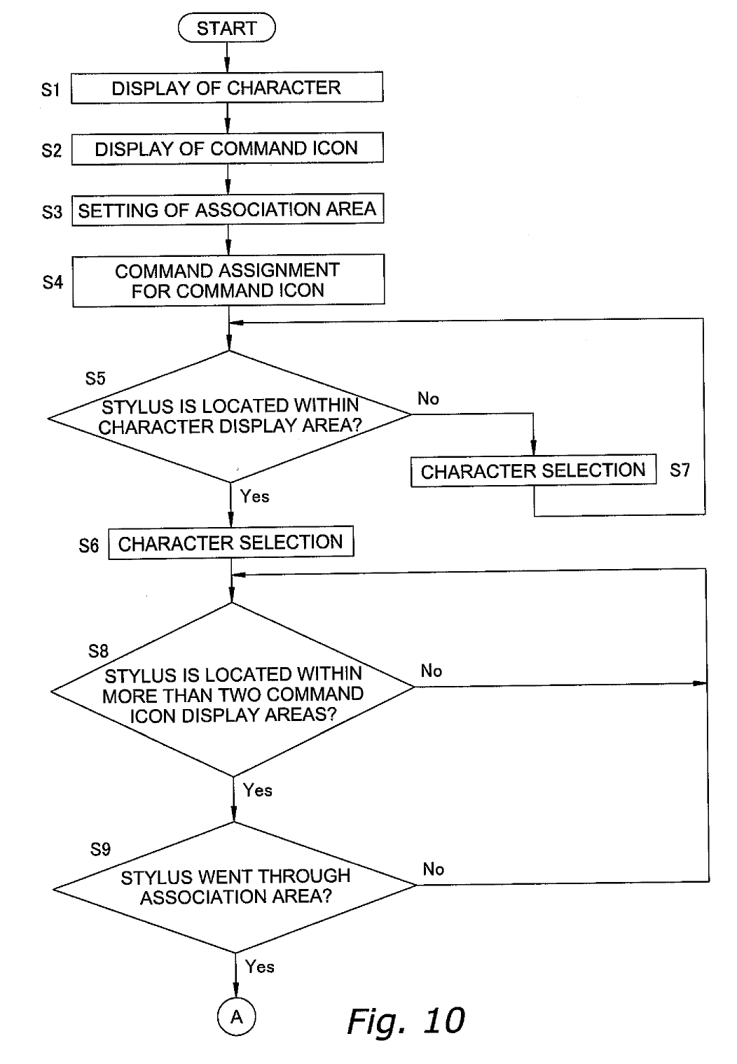

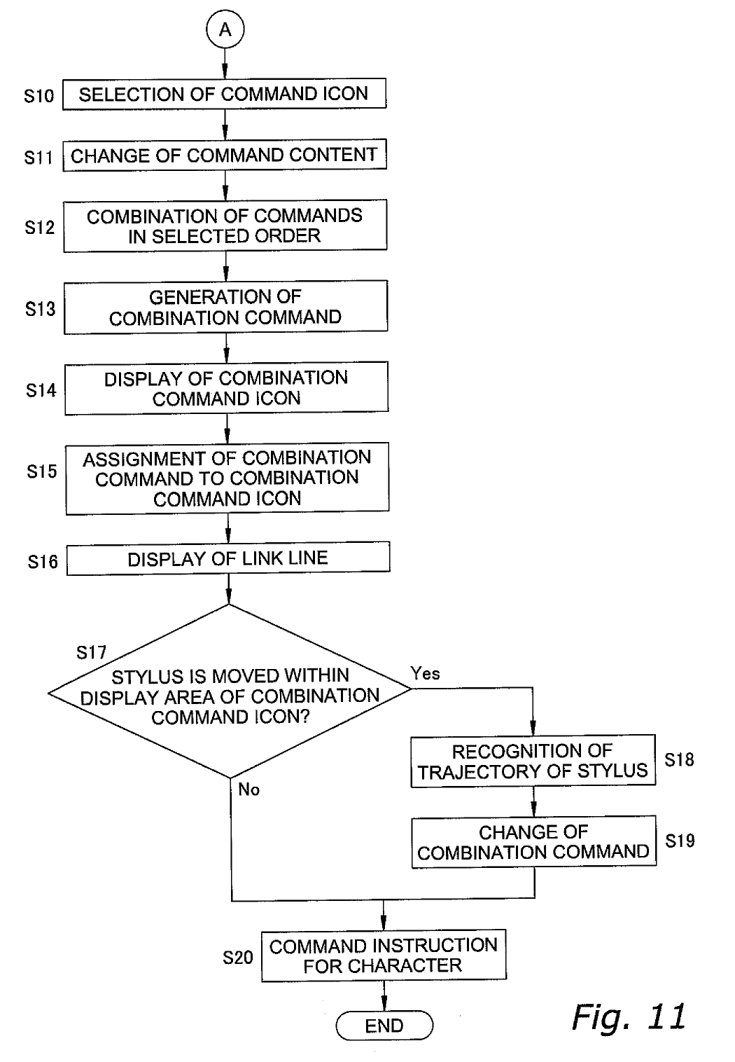

Based on the above described second example in FIG. 6, a process flow performed by the command instruction system in the battle simulation game in accordance with the present embodiment will be hereinafter explained in reference to a flow chart shown in FIGS. 10 and 11.

First, a plurality of squares formed by a plurality of grid lines and a plurality of tank characters 70 arranged on the plurality of squares are displayed on the upper portion of the bottom LCD monitor 3b (Step S1). Then, the plurality of command icons 71 are displayed on the lower portion of the bottom LCD monitor 3b (Step S2). Here, the command icons 71 includes, for instance, the 6-squares forward movement instruction icon 71a, the 6-squares backward movement instruction icon 71b, the 4-squares rightward movement instruction icon 71c, the 4-squares leftward movement instruction icon 71d, and the gunshot instruction icon 71e. Next, the association areas 72 to associate at least two command icons of the plurality of command icons 71 are set to the portions located above and below the command icons 71 on the bottom LCD monitor 3b (Step S3).

Subsequently, a command to move the tank character 70a forward by 6 squares, a command to move the tank character 70a backward by 6 squares, a command to move the tank character 70a in the rightward direction by 4 squares, a command to move the tank character 70a in the leftward direction by 4 squares, and a command to make the tank character 70a fire at the enemy, are respectively assigned to the 6-squares forward movement instruction icon 71a, the 6-squares backward movement instruction icon 71b, the 4-squares rightward movement instruction icon 71c, the 4-squares leftward movement instruction icon 71d, and the gunshot instruction icon 71e (Step S4).

Next, the control unit 10 (e.g., the CPU 11) judges if a position in which the stylus 90 contacts the monitor 3 is located within the display area of one of the tank characters 70 displayed on the monitor 3 (Step S5). If a position in which the stylus 90 contacts the monitor 3 is judged to be located within the display area of the tank character 70a displayed on the monitor 3 (Yes in Step S5), the tank character 70a is recognized and selected by the control unit 10 (e.g., the CPU 11) (Step S6). On the other hand, if it is judged that the position in which the stylus 90 contacts the monitor 3 is not located within the display area of one of the tank characters 70 displayed on the monitor 3, the tank character 70a is not selected by the control unit (e.g., the CPU 11) (Step S7) and Step S5 is performed again.

Next, if the tank character 70a is selected (Step S6), the control unit 10 (e.g., the CPU 11) judges if the position in which the stylus 90 contacts the monitor was located within the areas of at least two command icons 71 while the position in which the stylus 90 contacted the monitor 3 was being continuously recognized by the control unit 10 (e.g., the CPU 11) (Step S8). Next, if the CPU 11 judges that the position in which the stylus 90 contacted the monitor 3 is located within the display areas of at least two command icons 71 (Yes in Step S8), it is judged if the position in which the stylus 90 contacted the monitor 3 went through the inside of the association area 72 while the position in which the stylus 90 contacted the monitor 3 was being continuously recognized by the control unit 10 (e.g., the CPU 11) (Step S9). Next, if it was judged that the position in which the stylus 90 contacted the monitor went through the inside of the association area 72 (Yes in Step S9), at least two command icons are selected (Step S10).

For example, the stylus 90 is located within the display area of the 6-squares forward movement instruction icon 71a displayed on the monitor 3 while the stylus 90 is contacting with the bottom LCD monitor 3b. Then, the stylus 90 is moved to the association area 72 located above the command icons 71. Next, the stylus 90 is moved in the inside of the display area of the 4-squares rightward movement instruction icon 71c displayed on the monitor while the stylus 90 contacts the bottom LCD monitor 3b. Then, the stylus 90 is moved to the association area 72 located below the command icons 71. Next, the stylus 90 is moved in the inside of the display area of the gunshot instruction icon 71e displayed on the monitor while the stylus 90 is being contacted with the bottom LCD monitor 3b. Accordingly, the 6-squares forward movement instruction icon 71a, the 4-squares rightward movement instruction icon 71c, and the gunshot instruction icon 71e are selected, all of which the stylus 90 was located in.

Note that if the CPU 11 judges that the position in which the stylus 90 contacts the monitor is not located within the display areas of at least two command icons 71 (No in Step S8), the CPU 11 monitors the position in which the stylus 90 contacts the monitor 3 until the position in which the stylus 90 contacts the monitor 3 is located in the display area of the second command icon. Also, if it was judged that the position in which the stylus 90 contacts the monitor 3 did not go through the inside of the association area 72 (Yes in Step S9), information of the position in which the stylus 90 contacts the monitor, which was judged by the CPU 11, is cancelled by the CPU 11 and Step S8 is performed again.

Subsequently, if a desired command icon 71 is selected, the command content of the command icon 71 is changed by the control unit 10 (e.g., the CPU 11) depending on the number of selected command icons 71 (Step S11). Here, the desired command icon 71 includes, for instance, the 6-squares forward movement instruction icon 71a, 4-squares rightward movement instruction icon 71c, and the gunshot instruction icon 71e. For example, the 6-squares forward movement instruction command and the 4-squares rightward movement instruction command are respectively changed to a 2-squares forward movement instruction command and a 1-square rightward movement instruction command. Also, the changed commands are combined by the control unit 10 (e.g., the CPU 11) in an order that the command icons were selected (Step S12), and a combination command is generated based on the combined commands (Step S13). For example, the 2-squares forward movement instruction command, the 2-squares rightward movement instruction command, and the gunshot instruction command are respectively combined in an order of the 2-squares forward movement instruction command, the 2-square rightward movement instruction command, and the gunshot instruction command. Then, a combination command is generated based on the combined commands.

Accordingly, the combination command icon 75 is displayed on the bottom LCD monitor 3b (Step S14), and a combination command is assigned to the combination command icon 75 (Step S15). Then, a lead line (e.g., the link line 76) extending from the combination command icon 75 to the selected command icon is displayed on the bottom LCD monitor 3b (Step S16).

Next, the CPU 11 judges if a position in which the stylus 90 contacts the monitor was continuously moved within the display area of the combination command icon 75 (Step S17). Then, if the CPU 11 judges that the position in which the stylus 90 contacted the monitor was not continuously moved within the display area of the combination command icon 75 (No in Step S17), the tank character 70a is instructed to execute the combination command assigned to the combination command icon 17 based on the instruction by the CPU 11 (Step S20). For example, if the stylus 90 is once located within the display area of the combination command icon 75 and then lifted off the display area of the combination command icon 75, the tank character 70a is instructed to execute the combination command assigned to the combination command icon 75. Accordingly, the tank character 70a is allowed to fire at the enemy after the tank character 70a is moved forward by 2 squares and then moved in the rightward direction by one square.

On the other hand, if the CPU 11 judges that the position in which the stylus 90 contacted the monitor was continuously moved within the display area of the combination command icon 75 (Yes in Step S17), a trajectory of the positions in which the stylus 90 is contacted with the monitor 3 is recognized by the CPU 11 (Step S18). Accordingly, depending on the shape of the trajectory of the positions in which the stylus 90 contacted the monitor 3, the combination command assigned to the combination command icon 75 is changed to a command that is different from the combination command by the CPU 11 (Step S19), and the tank character 70a is instructed to execute the changed combination command (Step S20). For example, if a trajectory of the position in which the stylus 90 contacted the monitor is formed in a jagged shape including six pointed portions by moving the stylus 90 up and down a plurality of times within the display area of the combination command icon 75, the combination command comprised of the 2-squares forward movement instruction command, 2-squares rightward movement instruction command, and the gunshot instruction command is changed to a combination command comprised of a command cancel command corresponding to the jagged shape, and the tank character 70a is instructed to execute the command cancel command.

The above described process, which is comprised of steps S1 to S20, is configured to be repeatedly executed until the game is over.

### Other Embodiments

(a) In the above described embodiment, a case in which the portable game console 1 is used as an example of a computer to which the game program can be applied is described. However, it will be apparent to one of ordinary skill in the art from this disclosure that the computer (e.g., the game device) is not limited to the above described embodiment, and may be applied to a game device with which a monitor is separately provided, a monitor-integrated arcade game device, a personal computer that functions as a game device when a game program is executed therein, a workstation, or the like.

(b) In the above described embodiment, a case in which the battle simulation game is used in the game device of the present invention is explained. However, the present invention may be applied to any type of game, as long as it is a game in which a character is instructed to execute a command by operating a command icon.

(c) In the above described embodiment, a case in which the game device includes the association area setting component and the third input position judgment component. However, it is possible to execute a command instruction system even if the game device does not include the association area setting component and the third input position judgment component. In this case, if in the first input position judgment component, the control unit judged that a position in which the stylus 90 contacted the monitor was located within the display areas of at least two command icons 71 of the command icons 71, while the position in which the stylus 90 contacted the monitor was being continuously recognized by the control unit 10 (Yes in Step S8), the command icon is recognized and selected by the control unit 10 (Step S10).

(d) In the above described embodiment, a case in which the tank character 70a is displayed on the touch panel type monitor 3b is described. However, the tank character 70a may be configured to be displayed on the non-touch panel type monitor 3a. The selection of the tank character 70 is performed by operating the input unit 4.

(e) The present invention includes a program to execute the above described type of game, a program method to execute the game, and a computer-readable recording medium in which the program is recorded. For example, a computer-readable flexible disk, a semiconductor memory, a CD-ROM, a DVD, a MO, a ROM cassette, and the like may be utilized as the recording medium.

In the present invention, a plurality of command objects are displayed on the contact input type monitor 3b. A command is assigned to each of the plurality of command objects 71. If an input signal is input from the contact input type monitor 3b on this state, an input position on the contact input type monitor 3b is recognized based on the input signal from the contact input type monitor 3b. It is judged if the input position on the contact input type monitor 3b is located within the areas of at least two command objects 71 of a plurality of command objects while the input position is being continuously recognized. Subsequently, if it is judged that the input position on the contact input type monitor 3b was located within the display areas of the at least two command objects 71 of the plurality of command objects while the input position was being continuously recognized, the at least two command objects are selected. Next, a new command is generated based on the command assigned to each of the selected at least two command objects, and a character is instructed to execute the new command.

It is possible to select at least two command objects by locating the input position (e.g., the position in which the instruction device is contacted with the monitor) within the display areas of the at least two command objects displayed on the contact input type monitor 3b. Then, it is possible to generate a new command based on the command assigned to each of the selected at least two command objects. It is also possible to instruct a character to execute the new command. Accordingly, it is possible to easily instruct a character displayed on the contact input type monitor 3b to execute a plurality of commands.

As used herein, the following directional terms “forward, rearward, above, downward, vertical, horizontal, below and transverse” as well as any other similar directional terms refer to those directions of a device equipped with the present invention. Accordingly, these terms, as utilized to describe the present invention should be interpreted relative to a device equipped with the present invention.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A computer-readable medium encoded with a game program for executing a game comprising the steps of:
displaying a plurality of command objects on a monitor;
assigning a command to each of the command objects;
recognizing an input position on the monitor based on an input signal from the monitor, the input position corresponding to the input signal;
judging if the input position is located within display areas of at least two command objects of the command objects while the input position on the monitor is being continuously recognized;
selecting the at least two command objects if it is judged that the input position is located within the display areas of the at least two command objects while the input position on the monitor is being continuously recognized;
generating a new command based on the command assigned to each of the selected at least two command objects; and
instructing a character displayed on the monitor to execute the new command.

2. The computer-readable medium according to claim 1, further comprising the steps of
displaying a new command object corresponding to the new command on the monitor;
assigning the new command to the new command object; and
judging if the input position is located within a display area of the new command object,
wherein the character is instructed to execute the new command assigned to the new command object if it is judged that the input position is located within the display area of the new command object.

3. The computer-readable medium according to claim 1, further comprising the steps of
judging if the input position was continuously moved within the display area of the new command object;
recognizing a trajectory of the input position if it is judged that the input position is located within the display area of the new command object and if it is judged that the input position was continuously moved within the display area of the new command object;
changing the new command assigned to the new command object to a command that is different from the new command depending on the shape of the trajectory, and
wherein the character is instructed to execute the new command assigned to the new command object if it is judged that the input position is located within the display area of the new command object and if it is not judged that the input position was continuously moved within the display area of the new command object, and
the character is instructed to execute a command that is different from the new command and is assigned to the new command object if it is judged that the input position is located within the display area of the new command object and if it is judged that the input position was continuously moved within the display area of the new command object.

4. The computer-readable medium according to claim 1, further comprising the steps of
setting an association area to associate at least two command objects of the command objects to the monitor; and
judging if the input position is located within the association area while the input position on the monitor is being continuously recognized, and
wherein the at least two command objects are selected if it is judged that the input position is located within the display areas of the at least two command objects and if it is judged that the input position is located within the association area while the input position on the monitor is being continuously recognized.

5. The computer-readable medium according to claim 1, wherein
the new command is generated in the order that the input position is located within the display areas of the at least two command objects based on the command assigned to each of the selected at least two command objects.

6. The computer-readable medium according to claim 1, wherein
the new command is generated depending on a number of the selected command objects based on the command assigned to each of the selected at least two command objects.

7. A game device for executing a game comprising:
a command object display component configured to display a plurality of command objects on a monitor;
a command assignment component configured to assign a command to each of the command objects;
an input position recognition component configured to recognize an input position on the monitor based on an input signal from the monitor, the input position corresponding to the input signal;
a first input position judgment component configured to judge if the input position is located within display areas of at least two command objects of the command objects while the input position on the monitor is being continuously recognized;
an object selection component configured to select the at least two command objects if it is judged that the input position is located within the display areas of the at least two command objects while the input position on the monitor is being continuously recognized;
a command generation component configured to generate a new command based on the command assigned to each of the selected at least two command objects; and
a new command instruction component configured to instruct a character displayed on the monitor to execute the new command.

8. A method of executing a game comprising:
displaying a plurality of command objects on a monitor;
assigning a command to each of the command objects;
recognizing an input position on the monitor based on an input signal from the monitor, the input position corresponding to the input signal;
judging if the input position is located within display areas of at least two command objects of the command objects while the input position on the monitor is being continuously recognized;
selecting the at least two command objects if it is judged that the input position is located within the display areas of the at least two command objects while the input position on the monitor is being continuously recognized;
generating a new command based on the command assigned to each of the selected at least two command objects; and
instructing a character displayed on the monitor to execute the new command.
